(19) United States
(12) Patent Application Publication
(10) Pub. No.: US 2006/0217866 A1
(43) Pub. Date: Sep. 28, 2006

(54) Method for controlling the speed of a vehicle

(76) Inventor: Rainer Moebus, Korntal (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/546,592

(22) PCT Filed: Dec. 13, 2003
(86) PCT No.: PCT/EP03/14218

§ 371 Date: Apr. 19, 2006

(30) Foreign Application Priority Data
Feb. 20, 2003 (DE) 103 07 169.5

(51) Int. Cl. G08G 1/00

(52) U.S. Cl. 701/70; 701/117; 701/93

(57) ABSTRACT

In a method for controlling the speed of a vehicle, a future traffic situation is predicted as a function of the acceleration of the controlled vehicle. The future traffic situation is then evaluated with a cost function which is defined in such a way that its value increases with the number and relevance of the other vehicles which are traveling in front and are relevant to the controlled vehicle. The value of the acceleration which minimizes the cost function is then determined as an acceleration setpoint value, and the acceleration of the vehicle is adjusted to this value.

### BACKGROUND AND SUMMARY OF THE INVENTION

This application claims the priority of German patent document 103 07 169.5, filed Feb. 20, 2003 (PCT International Application No. PCT/EP2003/014218, filed Dec. 13, 2003), the disclosure of which is expressly incorporated by reference herein.

The invention relates to a method for controlling the speed of a vehicle.

Such methods and the devices for carrying them out, which are frequently referred to by the name “adaptive cruise controller” or “cruise controller with inter-vehicle distance control”, permit the speed of a vehicle to be adjusted to a value which can be predefined by the driver of the vehicle when the roadway is free. However, if another vehicle traveling in front stands in the way of this adjustment, the other vehicle is selected as a control target and the speed of the vehicle is controlled in such a way that it follows the control target at a specific speed-dependent distance. As a result, the speed of the controlled vehicle is adapted to that of the control target.

The detection of the other vehicle which is traveling in front and the determination of its distance from the controlled vehicle are usually carried out with a radar device which is provided on the controlled vehicle. If a plurality of other vehicles are located in front of the controlled vehicle, the most relevant of these vehicles is selected as a control target and the distance adjustment is carried out exclusively to this control target.

In a method disclosed in European patent document EP 716 949 B1, another vehicle which is traveling in front on a relatively fast adjacent lane is selected as a new control target if there is a risk that it would otherwise be illegally overtaken by the controlled vehicle.

One essential disadvantage of the previously known methods is another vehicle cutting into a lane of traffic can lead to unpleasant braking operations, due to an abrupt change of the control target which results from the cutting in. In the most unfavorable case, the device reacts too late to the other vehicle which is cutting in so that under certain circumstances it may no longer be possible to avoid a collision with this vehicle.

One object of the invention, therefore, is to provide an improved method of the type described, in which travel safety and comfort are enhanced.

This and other objects and advantages are achieved by the method according to the invention, which is based on predictive evaluation of the future traffic situation taking into account other vehicles which are traveling in front of the controlled vehicle in its lane or in an adjacent lane. Such predictive consideration permits prompt reaction to another vehicle which cuts in front of the controlled vehicle. According to the invention, the future traffic situation is predicted by reference to movement parameters of the vehicles which are traveling in front, with the prediction being carried out as a function of the setpoint acceleration of the controlled vehicle which can be predefined as a free parameter. The movement parameters, are in each case, relative position with respect to the controlled vehicle, and the speed of the other vehicles which are traveling in front. Preferably acceleration of the other vehicles which are traveling in front is also taken into account.

The future traffic situation is evaluated by reference to a cost function which is defined in such a way that its value increases with the number and relevance of the other vehicles which are traveling in front of the controlled vehicle. In this context the setpoint acceleration of the controlled vehicle at which the cost function would assume a minimum value is determined. This value is subsequently used as a basis for the acceleration setpoint value for controlling the acceleration of the controlled vehicle. Speed control is thus based on controlling the acceleration.

In contrast to the prior art, in which only one of the other vehicles is selected as the control target, in the method according to the invention, a process is carried out to determine which of the other vehicles has what degree of restrictive influence on the travel of the controlled vehicle; and the other vehicles are correspondingly taken into account in accordance with their relevance when the optimum acceleration determining the speed of the controlled vehicle is calculated.

Other vehicles which are traveling in front of the controlled vehicle in its lane at a distance which is less than the safety distance are preferably considered relevant; and the more the safety distance is undershot the greater the relevance. (I.e., the relevance of the other vehicles increases as the undershooting of the safety distance increases.)

Furthermore, other vehicles which are traveling in front of the controlled vehicle on an adjacent, faster lane are preferably also considered relevant. With this restriction it is possible to ensure that other vehicles are not overtaken on a slower lane. This is appropriate, for example, for countries such as Germany, which prohibit overtaking on the right on specific roads. Correspondingly, in countries which drive on the left it is possible to ensure that a prohibition on overtaking on the left is complied with.

In one advantageous embodiment of the method the cost function is defined as follows

$$J ( a ) = {Q}_{0} \cdot {f}_{0} ( a ) + {\sum }_{i = 1}^{i = n} ( {Q}_{i} \cdot {f}_{i} ( a ) )$$

where

i is an index which identifies the other vehicles which are traveling in front;

a is the setpoint acceleration of the controlled vehicle which is included in the prediction as a free parameter;

f₀(a) is an evaluation function which is assigned to the controlled vehicle and which is dependent on the differential amount between the predicted speed of the controlled vehicle and a desired speed which is predefined by the driver;

fᵢ(a) is an evaluation function which is assigned to the i-th other vehicle which is traveling in front, which evaluation function is dependent on the predicted undershooting of the safety distance of the controlled vehicle from the i-th other vehicle which is traveling in front;

Q₀ is a weighting factor which is assigned to the controlled vehicle; and

Qᵢ is a weighting factor which is assigned to the i-th other vehicle which is traveling in front.

The evaluation function fᵢ(a) which is assigned to the i-th other vehicle is in this case preferably defined according to the rule
fᵢ(a)=|dₘᵢₙ−dᵢ(a)|^{k}.
Here,

dₘᵢₙ represents the required safety distance of the controlled vehicle from a vehicle which is traveling in front;

dᵢ(a) represents the predicted longitudinal distance of the controlled vehicle, dependent on the setpoint acceleration of the controlled vehicle, from the i-th other vehicle; and

k represents an exponent where k≧1 (which is expediently set to the value 2).

The weighting factor Qᵢ which is assigned to the i-th other vehicle is preferably set to a predefined positive value if the i-th other vehicle is relevant to the controlled vehicle and is otherwise set to the value zero.

The evaluation function f₀(a) which is assigned to the controlled vehicle is preferably defined according to the rule
F₀(a)=|v₀(a)−v_{ref}|^{j}
where

v_{ref} represents the desired speed which is predefined by the driver, to which speed of the controlled vehicle is to be adjusted when the roadway is free;

v₀(a) represents the predicted speed, dependent on the setpoint acceleration of the controlled vehicle, of the controlled vehicle; and

j represents an exponent where j≧1 (which is expediently set to the value 2).

The weighting factor Q₀ which is assigned to the controlled vehicle is preferably predefined in such a way that the deviation between the speed and the desired speed when the roadway is free is equalized with a specific control speed.

The acceleration setpoint value is preferably limited to technically realizable acceleration values. The change in the acceleration setpoint value is also advantageously limited to a predefined maximum value in order to avoid excessive setpoint value jumps, which could be uncomfortable to vehicle occupants.

In one advantageous embodiment of the invention, the acceleration setpoint value is determined iteratively in a plurality of iteration steps and is used as a setpoint value for the acceleration control only after a predefined number of iteration steps.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a traffic situation; and

FIG. 2 is a flowchart for carrying out the method according to the invention.

### DETAILED DESCRIPTION OF THE DRAWINGS

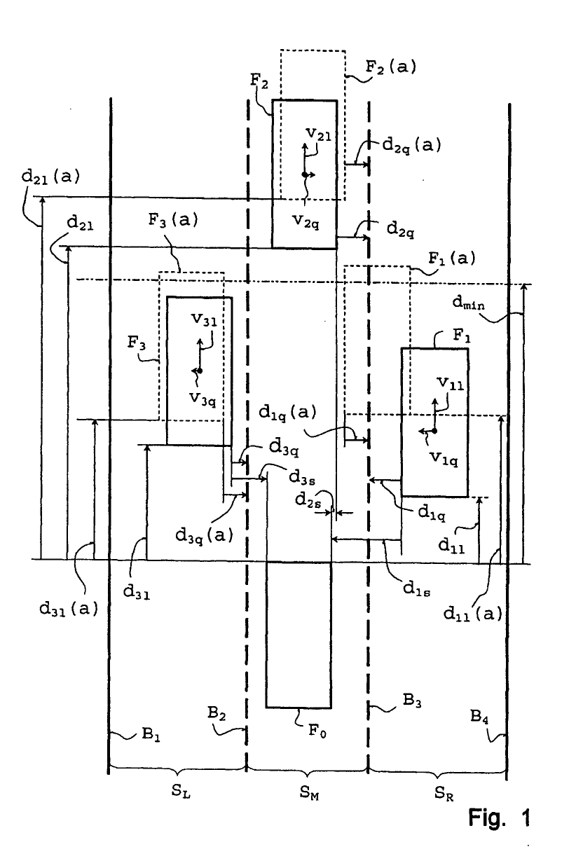

FIG. 1 is a schematic plan view of a traffic situation on a three-lane road, having lanes S_{L}, S_{M}, S_{R} marked by lane boundary lines B₁, B₂, B₃, B₄. In the figure, the vehicle whose speed v₀ is to be controlled (referred to below as the “controlled vehicle”) is referred to by the reference F₀. It has actuating means for generating actuating signals which are fed to the engine, to the transmission and/or to the vehicle brake system in order to control the acceleration.

The figure also shows three vehicles F₁, F₂, F₃ which are traveling ahead of the controlled vehicle F₀ and which are referred to below as “other vehicles”. In addition, the longitudinal speeds v₁ₗ, V₂ₗ, v₃ₗ and transverse speeds v_{1q}, v_{2q}, v_{3q} of the other vehicles F₁, F₂, F₃ and their longitudinal distances d₁ₗ, d₂ₗ, d₃ₗ and their lateral distances d₁ₛ, d₂ₛ, d₃ₛ from the controlled vehicle F₀ and their transverse distances d_{1q}, d_{2q}, d_{3q} from the lane S_{M} of the controlled vehicle F₀ are represented.

In addition, future positions F₁(a), F₂(a), F₃(a) of the other vehicles F₁, F₂, F₃ are indicated in the figure by dashed lines. These are positions which the other vehicles F₁, F₂, F₃ are predicted to assume after a predefined time (for example, two seconds) has expired. The resulting longitudinal distances and transverse distances are designated by d₁ₗ(a), d₂ₗ(a), d₃ₗ(a) and by d_{1q}(a), d_{2q}(a) and d_{3q}(a). The safety distance dₘᵢₙ of the controlled vehicle F₀, which is dependent on the speed of the controlled vehicle F₀ and should not be undershot for safety reasons, is also represented in the figure.

The controlled vehicle F₀ comprises a radar system as means for detecting the other vehicles F₁, F₂, F₃ which are traveling in front, and for determining the movement parameters of these vehicles. Of course, an infrared system or an image recording and image processing system could also be used. The variables: position and speed of the other vehicles F₁, F₂, F₃ and optionally also their acceleration are determined as movement parameters. These vectorial variables are determined here as relative variables with the controlled vehicle F₀ as a reference point.

The controlled vehicle F₀ also comprises image recording and image processing means for detecting the curvature of the lane by reference to the profile of the lane boundary lines B₂, B₃. The transverse distance d_{1q}, d_{2q} d_{3q} can thus also be determined for curved lanes from the lateral sensors d₁ₛ, d₂ₛ, d₃ₛ of the other vehicles F₁, F₂, F₃ from the controlled vehicle F₀ and the position of the controlled vehicle F₀ within its lane S_{M}.

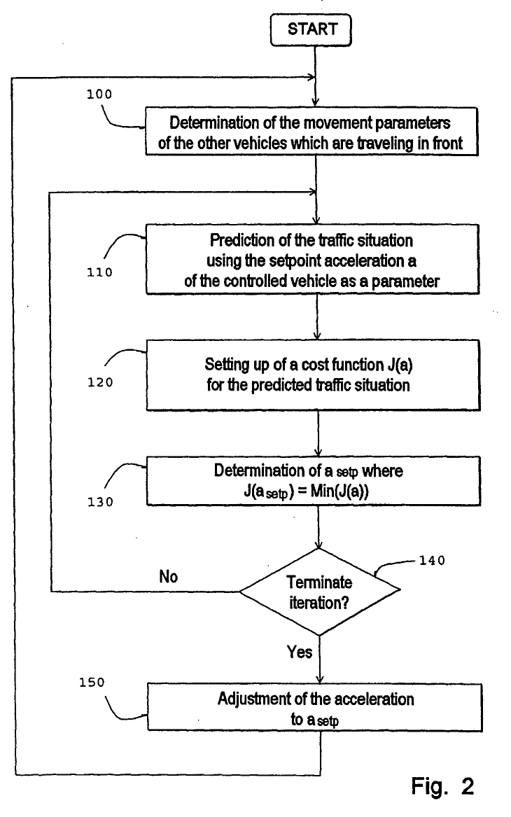

The method according to the invention is described below for the traffic situation illustrated in FIG. 1 with reference to the flowchart according to FIG. 2.

In FIG. 2, the movement parameters of the other vehicles F₁, F₂, F₃ which are traveling in front are determined in step 100 (i.e., their longitudinal and lateral distances d₁ₗ, d₂ₗ, d₃ₗ and respectively d₁ₛ, d₂ₛ, d₃ₛ from the controlled vehicle F₀, their longitudinal and transverse speeds v₁ₗ, v₂ₗ, v₃ₗ and respectively v_{1Q}, v_{2q} v_{3q}, and optionally also their longitudinal and transverse accelerations are determined. The decision as to whether a vehicle is traveling in front is taken by reference to its absolute speed which can be determined from its relative speed with respect to the controlled vehicle F₀ and the absolute speed of the controlled vehicle F₀. Stationary or oncoming objects are not taken into account. In step 100, the profile of the lane S_{M} of the controlled vehicle F₀, the speed of the controlled vehicle F₀ and the position of the controlled vehicle F₀ within the lane S_{M} are also determined.

In the next step 110, the future traffic situation is predicted using the movement parameters which are then known. (That is, the positions F₁(a), F₂(a), F₃(a) which the other vehicles F₁, F₂, F₃ are predicted to assume after the expiration of a predetermined time are determined). In this context, the prediction takes place as a function of the setpoint acceleration a of the controlled vehicle F₀ which is included in the prediction result as a free parameter (i.e., as a variable).

The setpoint acceleration a is the variable by which the future traffic situation can be influenced from the controlled vehicle F₀. The object of the method is then to find the value of the setpoint acceleration a which is associated with an optimum traffic situation and to implement this optimum traffic situation by adjusting the acceleration to the value which is found.

In order to achieve this, in step 120 a cost function J(a) is set up for the predicted traffic situation and the traffic situation is evaluated with the cost function J(a).

The cost function J(a) is in this case defined according to the relationship

$$J ( a ) = {Q}_{0} \cdot {f}_{0} ( a ) + {\sum }_{i = 1}^{i = n} ( {Q}_{i} \cdot {f}_{i} ( a ) )$$

where

i is an index which is respectively assigned to the other vehicles F₁, F₂, F₃, where i=1, 2, . . . n;

n is a value representing the number of the other vehicles F₁, F₂, F₃;

a is the setpoint acceleration a of the controlled vehicle F₀ which is included in the prediction as a free parameter;

f₀(a) is an evaluation function which is assigned to the controlled vehicle F₀;

fᵢ(a) is an evaluation function which is assigned to the i-th other vehicle Fᵢ;

Q₀ is a weighting factor which is assigned to the controlled vehicle F₀; and

Qᵢ is a weighting factor which is assigned to the i-th other vehicle.

For the case which is illustrated in FIG. 1 (where n=3, with other vehicles F₁, F₂, F₃), the function
J(a)=Q₀·f₀(a)+Qᵢ·fᵢ(a)+Q₂·f₂(a)+Q₃·f₃(a)
is obtained as the cost function J(a).

The evaluation function f₀(a) is defined according to the rule
f₀(a)=|v₀(a)−v_{ref}|^{j}
where v_{ref} represents a desired speed which is predefined by the driver and to which the speed on a clear roadway is to be adjusted, v₀(a) is the speed of the controlled vehicle F₀ which is predicted as a function of the setpoint acceleration a, and j represents an exponent where j≧1 and for which a value equal to 2 is expediently selected because the formation of absolute values is then dispensed with.

The evaluation function fᵢ(a) is defined according to the rule
fᵢ(a)=|dₘᵢₙ−dᵢ(a)|^{k}
where dₘᵢₙ represents the speed-dependent safety distance of the controlled vehicle F₀ from a vehicle which is traveling in front, dᵢ(a) represents the longitudinal distance dᵢₗ(a), predicted as a function of the setpoint acceleration a, of the i-th other vehicle Fᵢ from the controlled vehicle F₀, and k represents an exponent where k≧1 and for which a value equal 2 is expediently selected.

The weighting factor Qᵢ is set to a predefined positive value (for example, the value 1), if the i-th other vehicle Fᵢ is relevant to the control of the controlled vehicle F₀, and otherwise it is set to the value 0. This ensures that other vehicles which are not relevant do not make a contribution to the cost function J(a).

Another vehicle Fᵢ is considered to be relevant here if, according to the prediction, it is expected to be located on the lane S_{M} of the controlled vehicle F₀ and if its predicted longitudinal distance dᵢₗ(a) from the controlled vehicle F₀ is projected to undershoot the safety distance dₘᵢₙ of the controlled vehicle F₀. The decision as to whether the other vehicle Fᵢ is located on the lane S_{M} of the controlled vehicle F₀ is taken here by reference to its predicted transverse distance d_{iq}(a) from the lane S_{M} of the controlled vehicle F₀. The transverse distance d_{iq}(a) is determined here from the determined profile of the lane S_{M} of the controlled vehicle F₀, the position of the controlled vehicle F₀ within its lane S_{M} and from the lateral distance dᵢₛ to the i-th vehicle Fᵢ from the controlled vehicle F₀.

In the case illustrated in FIG. 1, only the other vehicle F₁ which is provided with the index i=1 would be predicted to be located on the lane S_{M} of the controlled vehicle F₀ within its safety distance dₘᵢₙ. As a result the weighting factors Qᵢ would have to be set as follows: Q₁=1 and Q₂=Q₃=0.

However it is advantageous to consider as relevant other vehicles which, although located on an adjacent lane would, however, be illegal to overtake when prevailing laws. This makes it possible to ensure that no illegal overtaking process is carried out, for example as a result of overtaking on the right-hand lane. If the other vehicle F₃ which is provided with the index i=3 is not to be overtaken on the middle lane S_{M} in the case illustrated in FIG. 1, the weighting factors Qᵢ would have to be set as follows: Q₁=Q₃=1 and Q₂=0.

The weighting factor Qᵢ which is assigned to the i-th other vehicle Fᵢ is thus predefined as a function of the predicted longitudinal distance dᵢₗ(a) between the i-th other vehicle Fᵢ and the controlled vehicle F₀, as a function of the speed-dependent safety distance dₘᵢₙ of the controlled vehicle F₀ and as a function of whether the i-th other vehicle Fᵢ is located to the left or right of the controlled vehicle F₀ on an adjacent lane.

The weighting factor Q₀ which is assigned to the controlled vehicle F₀ determines the adjustment rate, i.e., the adjustment speed with which the speed of the controlled vehicle F₀ is adjusted to the desired speed V_{ref} on a clear roadway. It is selected in accordance with the requested control speed.

After the cost function J(a) has been set up, in step 130 that value of the setpoint acceleration a at which the cost function J(a) assumes its minimum value is determined as the acceleration setpoint value aₛₑₜₚ.

The acceleration setpoint value aₛₑₜₚ can be refined by further iteration steps. For this purpose, in the next step 140 testing is carried out to determine whether the steps 110, 120, 130 have been repeated a specific number of times (for example, three). If so, the system branches to step 150; otherwise it branches to step 110. It is of course also possible to dispense with step 140 and to carry out the step 150 directly after step 130.

In step 150, the acceleration of the controlled vehicle F₀ is adjusted to the acceleration setpoint value aₛₑₜₚ by generating corresponding actuating signals which act on the engine, the transmission and/or the brakes of the controlled vehicle F₀.

Step 150 is followed in turn by step 100 in order to update the movement parameters of the other vehicles and to adapt the acceleration setpoint value aₛₑₜₚ to the current traffic situation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. A method for controlling the speed of a vehicle taking into account other vehicles that are traveling in front and whose respective position and speed are determined with respect to the controlled vehicle as movement parameters, said method comprising:
(a) predicting a future traffic situation by reference to the movement parameters of the other vehicles which are traveling in front, as a function of the setpoint acceleration of the controlled vehicle, which can be predefined as a free parameter;
(b) evaluating the future traffic situation by reference to a cost function whose value increases with the number and relevance of the other vehicles that are traveling in front, and are relevant to the controlled vehicle;
(c) determining an acceleration setpoint value of the controlled vehicle for which the cost function assumes a minimum value; and
(d) adjusting the acceleration of the controlled vehicle to the acceleration setpoint value.

13. The method as claimed in claim 12, wherein:
other vehicles which are traveling in front of the controlled vehicle in its lane at a distance which is less than a safe distance are considered relevant; and
the relevance of said other vehicles increases with the distance by which the safety distance is undershot.

14. The method as claimed in claim 13, wherein other vehicles that are traveling ahead of the controlled vehicle in an adjacent, faster lane are considered relevant.

15. The method as claimed in claim 14, wherein acceleration of the other vehicles which are traveling in front is determined as a further movement parameter for these vehicles, and is used as a basis for predicting the traffic situation.

16. The method as claimed in claim 15, wherein the cost function is defined according to the relationship
$$J ( a ) = {Q}_{0} \cdot {f}_{0} ( a ) + {\sum }_{i = 1}^{i = n} ( {Q}_{i} \cdot {f}_{i} ( a ) )$$
wherein
i is an index which identifies the other vehicles which are traveling in front;
a is the setpoint acceleration of the controlled vehicle which is included in the prediction as a parameter;
f₀(a) is an evaluation function which is assigned to the controlled vehicle and which is dependent on the differential between the predicted speed of the controlled vehicle and a desired speed which is predefined by the driver;
fᵢ(a) is an evaluation function which is assigned to the i-th other vehicle which is traveling in front, which evaluation function is dependent on the predicted undershooting of the safety distance of the controlled vehicle from the i-th other vehicle which is traveling in front;
Q₀ is a weighting factor which is assigned to the controlled vehicle (F₀); and
Qᵢ is a weighting factor which is assigned to the i-th other vehicle which is traveling in front.

17. The method as claimed in claim 16, wherein the evaluation function which is assigned to the i-th other vehicle corresponds to the rule
fᵢ(a)=|dₘᵢₙ−dᵢ(a)|^{k}
wherein
dₘᵢₙ represents the safety distance of the controlled vehicle from a vehicle which is traveling in front;
dᵢ(a) represents predicted longitudinal distance of the controlled vehicle, dependent on the setpoint acceleration of the controlled vehicle, from the i-th other vehicle; and
k represents an exponent, where k≧1.

18. The method as claimed in claim 17, wherein the weighting factor which is assigned to the i-th other vehicle is set to a predefined positive value if the i-th other vehicle is relevant to the controlled vehicle, and is otherwise set to the value zero.

19. The method as claimed in claim 18, wherein the evaluation function which is assigned to the controlled vehicle corresponds to the rule
F₀(a)=|v₀(a)−v_{ref}|^{j}
wherein
v_{ref} represents a desired speed which is predefined by the driver of the controlled vehicle;
v₀(a) represents predicted speed, dependent on the setpoint acceleration of the controlled vehicle, of the controlled vehicle; and
j represents an exponent, where j≧1.

20. The method as claimed in claim 19, wherein the weighting factor which is assigned to the controlled vehicle is predefined as a function of a desired control speed with which the speed of the controlled vehicle is to be adjusted to the desired speed when the roadway is free.

21. The method as claimed in claim 20, wherein:
the acceleration setpoint value is limited to technically realizable values; and
the change in the acceleration setpoint value is limited to a predefined maximum value.

22. The method as claimed in claim 21, wherein the method steps a to c are repeated for a predefined number of times before the method step d is carried out.
